(19) United States
(12) Patent Application Publication
(10) Pub. No.: US 2007/0204271 A1
(43) Pub. Date: Aug. 30, 2007

(54) Method and system for simulating a multi-CPU/multi-core CPU/multi-threaded CPU hardware platform

(76) Inventors: Andrew Gaiarsa, Carp (CA); Maarten Koning, Bloomfield (CA)

Correspondence Address: FAY KAPLUN & MARCIN, LLP, 15O BROADWAY, SUITE 702, NEW YORK, NY, 10038, US

(21) Appl. No.: 11/365,632

(22) Filed: Feb. 28, 2006

(51) Int. Cl. G06F 9/46

(52) U.S. Cl. 718/107

(57) ABSTRACT

Described is a system and method for loading a target operating system into a host operating system, wherein the host processing space includes a memory pool, mapping the memory pool into a plurality of processes, scheduling tasks within one of the processes to create a multitasking environment, forking the plurality of processes, sharing the mapped memory pool and the loaded target operating system with the forked plurality of processes, thereby providing the plurality of processes with shared access to the memory pool and managing the scheduled tasks within the multitasking environment.

### BACKGROUND

Multitasking allows a plurality of processes (or tasks) to share a common processing resource, such as a single central processing unit (“CPU”). When the resource is a single CPU, the resource may only actively execute the instructions for one of the processes at any given time. In order to allow for multiple processes to perform, multitasking may be used to schedule (or assign) which one of the processes may be running at a specific instance while other processes wait in turn for access to the processing resource. The exchanging assignments of which processes have access to the processing resource may be termed “context switching.” When a processing resource is able to perform context switching at a high frequency, the effect will closely resemble a single processing resource executing a plurality of processes virtually at the same time.

In a system capable of preemptive multitasking, a hardware system may be allowed to interrupt any currently running process in order to provide a separate process with access to the processing resource. Through the use of a scheduler during preemptive multitasking, various processes may be allotted a period of access time to the processing resources. In addition, multitasking may be useful in real-time operating systems (“RTOS”). Within a RTOS, a number of unrelated external applications may be controlled by a single processor system. This single processor system may include a hierarchical interrupt component, as well as a process prioritization component. Both of these components may be used to ensure that vital applications are given a greater share of the available time of the processing resource.

The threads of execution may be defined as processes that run in the same memory context of a processing resource. As opposed to multitasking where the processes are independent of each other, multithreading may be described as a manner for an application to split into a plurality of simultaneously running processes. In other words, multiple threads of execution may share the state of information of a single process, and share memory and other resources directly. Similar to multitasking, context switching may be used between multiple threads. However, threads of an application may allow for truly concurrent execution. Threads may be scheduled preemptively to allow for an efficient manner of exchanging data between cooperating multiple processes while the processes share their entire memory space. A multithreaded application may operate more efficiently within an operating environment that has multiple CPUs or CPUs with multiple cores. The present invention relates to a simulation environment wherein the simulated target hardware platform is composed of multiple CPUs, a CPU composed of multiple cores, or a multi-threaded CPU

### SUMMARY OF THE INVENTION

A method for loading a target operating system into a host operating system, wherein the host processing space includes a memory pool, mapping the memory pool into a plurality of processes, scheduling tasks within one of the processes to create a multitasking environment, forking the plurality of processes, sharing the mapped memory pool and the loaded target operating system with the forked plurality of processes, thereby providing the plurality of processes with shared access to the memory pool and managing the scheduled tasks within the multitasking environment.

A system having a loading element loading a target operating system into a host operating system, wherein the host processing space includes a memory pool, a mapping element mapping the memory pool into a plurality of processes, a scheduling element scheduling tasks within one of the processes to create a multitasking environment, a forking element forking the plurality of processes, a sharing element sharing the mapped memory pool and the loaded target operating system with the forked plurality of processes, thereby providing the plurality of processes with shared access to the memory pool and a managing element managing the scheduled tasks within the multitasking environment.

A computer readable storage medium including a set of instructions executable by a processor, the set of instructions operable to load a target operating system into a host operating system, wherein the host processing space includes a memory pool, map the memory pool into a plurality of processes, schedule tasks within one of the processes to create a multitasking environment, fork the plurality of processes, share the mapped memory pool and the loaded target operating system with the forked plurality of processes, thereby providing the plurality of processes with shared access to the memory pool and manage the scheduled tasks within the multitasking environment.

### BRIEF DESCRIPTION OF THE DRAWINGS

FIG. 1 shows an exemplary method for simulating a multiple CPU hardware environment on a host operating system according to the present invention.

FIG. 2 shows an exemplary simulation environment for simulating a multiple CPU hardware environment on a host operating system according to the present invention.

### DETAILED DESCRIPTION

The present invention may be further understood with reference to the following description and the appended drawings, wherein like elements are referred to with the same reference numerals. The exemplary embodiments of the present invention describe a method and system for simulating a multiple CPU target hardware environment on a host operating environment. In general, the present invention relates to loading a target computer environment (operating system and processor/hardware abstraction layer) into the memory of a host computing environment, wherein the memory of the host computer environment is mapped into multiple processes. The loaded target computer environment may then be responsible for the management of multiple threads of execution. It should be noted that the loaded target computer environment may be a comprehensive prototyping and simulation application for executing object modules while utilizing a board support mechanism.

Throughout this description, the simulation of the target hardware operating environment may be described as having multiple CPUs. However, there may be a variety of hardware platforms that the present invention may simulate. Specifically, the technique according to the present invention may be applied equally to simulating either a multi-CPU target hardware platform, wherein the hardware contains multiple identical CPU processing chips; a multi-core CPU target hardware platform, wherein a single CPU processing chip contains multiple identical processor cores; or a multi-threaded CPU target hardware platform, wherein a single CPU processing chip provides multiple virtual processing elements.

According to the present invention, a thread of execution (or simply “thread”) may be defined as a computational entity scheduled for execution on a processor. The thread may be utilized by a program unit, such as a procedure, loop, task, or any other unit of computation. Thus, threads of execution may be a way for a program to be split into multiple tasks that run simultaneously. In addition, multiple threads may be executed in parallel on an operating system. The execution, or multithreading, may occur by time slicing, wherein a single processor may switch between threads, or by multiprocessing, wherein the threads may be executed on separate processors.

The process of multitasking may be defined as a method by which multiple computational tasks share a common processing resource, generally a CPU. Since a single CPU may only perform (or actively execute) one task at a given point in time, multitasking allows the single CPU to schedule which task has access to the processing resource in order to be the one running task at that given time. While a single running task is being executed, there may be one or more unexecuted tasks awaiting access to the processing resource. A context switch may be utilized during the multitasking process, wherein the context switch reassigns the CPU from one task to another. In addition, a context switch may include a register context switch, a task context switch, a thread context switch, and a process context switch.

According to the present invention, the multiple processes of the host operating system may execute the shared code and manipulate the shared data. This execution by the multiple processes by way of the context switch may provide the illusion of an operating environment having multiple CPUs. Thus, even within a computing environment that has multiple CPUs, the process of multitasking may allow for several more tasks to be executed by the computing environment than there are CPUs. Furthermore, each process may represent an individual CPU from the perspective of the target computer environment.

While a host operating system having multiple CPUs may execute multiple processes concurrently, the host computer environment would not need multiple CPUs (or cores) in order to provide for an effective simulation. In an exemplary single CPU host computer system, traditional process scheduling may be performed by a scheduler through periodically recalculating the priority of processes. Additionally, the processes in this exemplary example may be simulated CPUs. In order to assess the priority of the processes, the scheduler may give more CPU access to processes that have not recently used CPU time, thereby increasing the priority of the process. Likewise, any long running processes may be automatically lowered in priority. This recalculating by the scheduler may provide for a relatively random execution of the simulated CPUs from the perspective of the target operating system. Thus, even though more than one of the host operating system processes may not be concurrently executed, the target operating system may not be aware of this.

Within the code and data of the target operating system, there are various threads of execution that are occurring beyond the control of the target operating system. Furthermore, any concurrency issues may be exposed by the mutual exclusion mechanisms exercised by the target operating system.

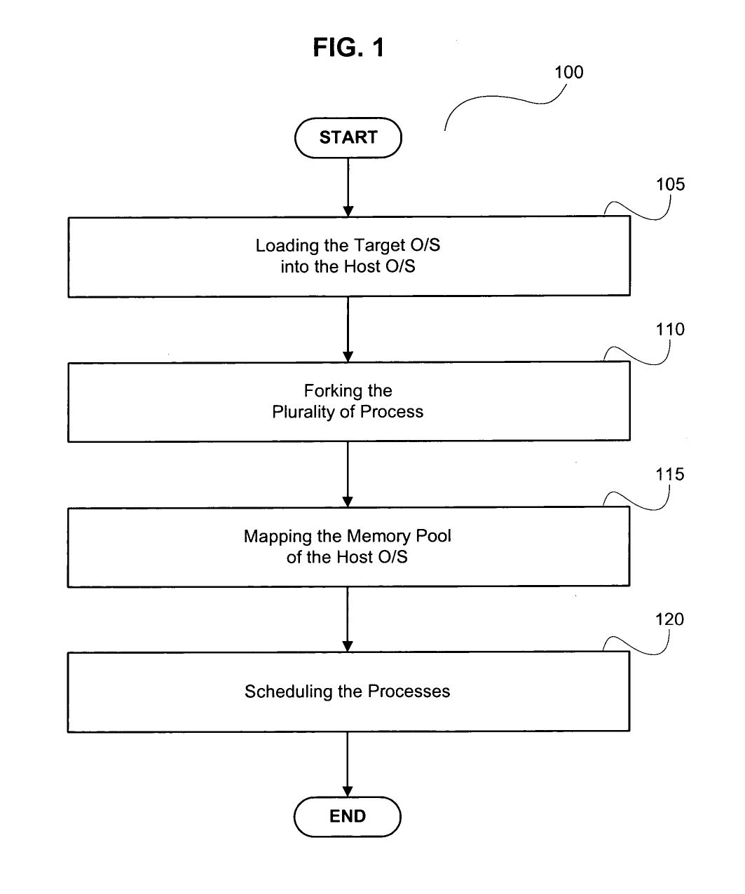

FIG. 1 shows an exemplary method 100 for simulating a multiple CPU hardware environment on a host operating system. In general, this method 100 involves loading a target operating system into the memory of the host operating system and mapping the memory of the host operating system into multiple processes. Once the target operating system has been loaded into the host operating system, the target operating system may then be responsible for the management of multiple threads of execution. The target operating system may be an integrated simulator that allows for immediate software development.

In a preferred embodiment of the present invention, the method 100 may be implemented in a prototyping and simulation application for multitasking activities with respect to priorities and preemptions. This application may be a comprehensive simulating and prototyping program intended to assist in the development of embedded systems using custom hardware. This application may be capable of testing a large portion of application software while it is in the early stages of the development. Additionally, this application may allow developers to create prototype applications before actual target hardware becomes available. In other words, the use of this application may allow a developer to avoid purchasing the target hardware while still creating an application module without direct hardware access during the early stages in the development of the software.

The target hardware operating system of an exemplary embodiment of the present invention may be a real-time operating system (“RTOS”) of the type generally used in embedded systems. The RTOS may include a multitasking kernel with preemptive scheduling and interrupt response. In addition, the RTOS may further include an input/output file system, inter-task communications, and synchronization facilities. The feature of the RTOS may also include memory management, multiprocessor facilities, a shell for user interface, symbolic and source level debugging components, as well as a performance monitoring component. The development of the RTOS may be done on a host machine by means of the prototyping and simulation application. This application may be used to cross-compile target software to run on various target CPU environments as well as on the host machine. This application may accurately implement the features of the RTOS and support a plurality of shared targets in order to provide for precise simulation for efficient prototyping.

According to the exemplary method of the present invention, in step 105 the target operating system may be loaded into the host operating system. Specifically, a prototyping and simulation application may load an object module (e.g., a scaleable processor architecture (“SPARC”) executable code, such as a binary image of the RTOS) into process space of the application. By loading the target operating system, the process execution may be transferred to an entry point of the object module. This entry point may be specified in an executable and linkable format (“ELF”) header of the object module. Thereafter, the target operating system may provide a multitasking environment by scheduling tasks within a single process (i.e., CPU), wherein the scheduling tasks may be defined as context switching.

Once the object module has been loaded into the process space, the application may provide a multi-CPU simulation environment. In step 110 the prototyping application “forks” a plurality of processes, wherein the number of forked processes may equal the number of simulated CPUs. It should be noted that forking may be defined as a means of duplicating a thread of execution within a multitasking environment. Within either a multitasking or multithreading operating system, forking may be accomplished when an application generates a copy of itself.

The execution of the forked processes may provide for a multi-CPU simulation environment. As described above, the object module of the target operating system may contain an entry point for the transfer of the process execution. Thus, the execution of the forked processes may be transferred to the entry point of the object module in accordance with the ELF header of the object module. After the plurality of processes have been forked, the target operating system may provide a multitasking environment by scheduling applications across the plurality of simulated CPUs that are represented by the equal number of forked processes.

In order to allow for the sharing of the processing resource, in step 115 the memory of the host operating system is mapped into the plurality of forked processes. The host operating system may include a memory pool that may be shared with these multiple processes. In addition, the object module may also be shared with the forked processes. The sharing is accomplished by mapping memory for the memory pool by way of a mapping operation. Memory mapping may be described as a process in which the object module is connected to an address bus and data bus of a processor. The mapping of the object module may allow for the object module code and data to be accessible for reading and writing by the processor. Thus, the multiple processes of the host operating system may execute the shared code and manipulate the shared memory pool, thereby creating the illusion of an environment containing multiple CPUs. In other words, each of the processes may represent a separate CPU from the perspective of the target operating system.

In one exemplary embodiment, the mapping operation may be termed an mmap( ) operation that specifies a flag parameter (e.g., MAP_SHARED) to indicate the portion of the memory pool that is to be shared. Memory shared by the mmap( ) operation is kept visible across the fork processes. In addition, an object module that is mmapped may allow the applications to share the memory area that the object module encompasses. This may avoid the need to load the object module for each application that would need access to it. Therefore, following the forking of the multiple processes, the source code may be loaded into the mapped memory region of the host operating system by the exemplary mmap( ) operation. The mapping type parameter (i.e., MAP_SHARED) may be retained and visible across the forked processes, wherein each process may represent a simulated CPU. Thus, the plurality of processes (i.e., CPUs) may have shared access to all of the memory that is visible to the target operating system.

In step 120, the processes may be scheduled by a scheduler. As described above, the scheduler may assign and continuously recalculate the priority of the plurality of the processes. The priority of the processes may be based on, for example, how recently a process has been provided with access to the processing resource, how long a process has been occupying the time of the processing resource, etc. Furthermore, in order to properly schedule the processes across multiple CPUs, the host operating system may utilize appropriate symmetric multiprocessing (“SMP”) techniques to manage the multiple CPUs. The loaded target operating system may be responsible for managing the multiple processes or threads of execution through the use of these SMP techniques. According to an exemplary embodiment of the present invention, the SMP technique may be a spin lock mechanism. A spin lock may be described as a mechanism in which a thread of execution waits in a locked loop and repeatedly checks for the availability of a resource. Once the resource becomes available, the loop is unlocked (or released) and the thread is provided with access to the resource.

According to an exemplary embodiment of the present invention, the prototyping and simulation application may support a board support mechanism for identifying a CPU instance. A CPU instance may be a representation of which CPU is being used to run a given process. In other words, a CPU instance may be defined as a full kernel of software, responsible for providing access to the processing resource and for scheduling the time with the resource. Specifically, the board support mechanism may be a sysCpuIndexGet( ) function, wherein the function may operate to return an index number identifying the current CPU instance. In an operating environment when N represents the number of processes, and thus, the number of CPUs, the index number returned by the board support mechanism may be a number between 0 and N−1.

In addition, the operating environment may further include an inter-processor interrupt (IPI) mechanism. An EPI may be defined as a specific type of interrupt, or an asynchronous signal, used in a multiprocessing environment in order to allow for one processing resource to interrupt the activity on another processing resource. According to an exemplary embodiment of the present invention, the IPI mechanism may issue low-level kernel directives across the plurality of CPUs. The IPI mechanism may be based on a software signals facility present in the prototyping and simulation application. Thus, a request by the target operating system to issue an interrupt signal to a specific CPU may result in the prototyping and simulation application of the present invention raising a signal against the specific process that represents the aforementioned CPU.

By implementing the present invention, a software developer may be provided with an enhanced development environment, specifically for simulating and developing a target hardware operating system on a host operating system. This may allow for quick and simplified software development while reducing the cost associated with continued maintenance and support for the target operating system. Furthermore, the present invention may allow for simulated environments without the need of implementing actual hardware. Thus, the users of this invention may detect and resolve any concurrency issues in the programs performed within the simulated environment. This may be useful when number of target hardware boards is either limited or not yet available.

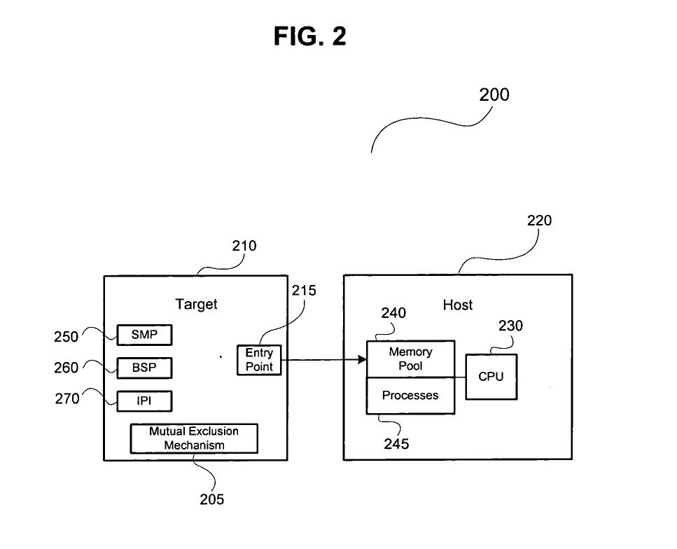

FIG. 2 shows an exemplary simulation system 200 for simulating a multiple CPU hardware environment on a host operating system 220. According to an exemplary embodiment of the present invention, the host operating system 220 may include a CPU 230, and a memory pool 240. The memory pool 240 of the host operating system 220 may be mapped into a plurality of host operating system processes 245.

A target operating system 210 may be a prototyping and simulation application to allow for efficient software development. This target operating system 210 may be loaded into the memory pool 230 of the host operating system 220, wherein the target operating system 210 may be a real-time operating system having a specified entry point 215. Once each of the plurality of process 245 uses the specified entry point 215 of the target operating system 210, the target operating system 210 may then be responsible for managing multiple threads of executions. It should be noted that the target operating system 210 may include a symmetric multiprocessing (SMP) mechanism 250, a board support package (BSP) mechanism 260, and an inter-processor interrupt (IPI) mechanism 270 as well as a mutual exclusion mechanism 205 that may be exercised to expose any concurrency issues associated with the multiple threads of execution occurring within the code of the target operating system 210.

By executing shared threads and manipulating the shared memory pool 240, the plurality of processes 245 may provide the appearance of a multi-CPU operating environment from the perspective of the target operating system 210. Thus, the present invention may be used to simulate a multi-CPU target hardware platform on the single CPU host operating system 220 through the use of scheduling (or context switching) the plurality of processes 245 within the single CPU 230.

Furthermore, the SMP mechanism 250 may be implemented to properly schedule the execution of processes 245 across the simulated multiple CPUs within the target operating system 210, wherein the SMP mechanism 250 may be a spin lock mechanism. Thus the SMP mechanism 250 may be employed to manage the simulated multiple CPUs. The BSP mechanism 260 may be implemented within the simulated multiple CPU environment to identify the current CPU instance within the target operating system 210, which may represent the CPU in which a given process is being executed on. For example, the BSP function sysCpuIndexGet( ) may be used to return an index number between 0 and N−1, wherein the index number represents the current CPU instance. Finally, the IPI mechanism 270 may be implemented to issue directives across the simulated multiple CPUs within the target operating system 210. As described above, the IPI mechanism 270 may be required in order to allow the SMP-capable operating systems to issue low-level kernel directives across the simulated multiple CPUs. The EPI mechanism 270 may be based on a software signals facility present in the prototyping and simulation application. For example, a request by the target operating system 210 to issue an interrupt signal to a specific CPU may result in the raising a signal against the specific process that represents the aforementioned CPU. Thus, these directives may be used to interrupt a process on a current CPU to allow for the execution of another process.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A method, comprising:
loading a target operating system into a host operating system, wherein the host processing space includes a memory pool;
mapping the memory pool into a plurality of processes;
scheduling tasks within one of the processes to create a multitasking environment;
forking the plurality of processes;
sharing the mapped memory pool and the loaded target operating system with the forked plurality of processes, thereby providing the plurality of processes with shared access to the memory pool; and
managing the scheduled tasks within the multitasking environment.

2. The method of claim 1, wherein the managing step further comprises the sub-step of:
implementing at least one symmetric multiprocessing mechanism within the target operating system.

3. The method of claim 1, further comprising:
implementing a board support mechanism within the target operating system, wherein the board support mechanism identifies an instance of one of the processes.

4. The method of claim 1, further comprising:
implementing an inter-processor interrupt mechanism within the host operating system, wherein the inter-processor interrupt mechanism issues a signal to interrupt an execution of one of the processes.

5. The method of claim 1, wherein the host operating system is a multi-CPU hardware platform that comprises a plurality of CPU processors.

6. The method of claim 1, wherein the host operating system is a multi-core CPU hardware platform that comprises a processor having a plurality of processor cores.

7. The method of claim 1, wherein the host operating system is a multi-threaded CPU hardware platform that comprises a processor having a plurality of virtual processing elements.

8. The method of claim 1, wherein the target operating system is an object module for scaleable processor architecture.

9. The method of claim 1, wherein the target operating system is a fully linked object module in ELF format comprising an ELF header.

10. The method of claim 9, further comprising:
transferring an execution of the forked plurality of processes to an entry point of the object module in accordance with the ELF header.

11. A system, comprising:
a loading element loading a target operating system into a host operating system, wherein the host processing space includes a memory pool;
a mapping element mapping the memory pool into a plurality of processes;
a scheduling element scheduling tasks within one of the processes to create a multitasking environment;
a forking element forking the plurality of processes;
a sharing element sharing the mapped memory pool and the loaded target operating system with the forked plurality of processes, thereby providing the plurality of processes with shared access to the memory pool; and
a managing element managing the scheduled tasks within the multitasking environment.

12. The system of claim 11, wherein the managing element further comprise:
at least one symmetric multiprocessing mechanism within the target operating system.

13. The system of claim 11, further comprising:
a board support mechanism within the target operating system, wherein the board support mechanism identifies an instance of one of the processes.

14. The system of claim 11, further comprising:
an inter-processor interrupt mechanism within the host operating system, wherein the inter-processor interrupt mechanism issues a signal to interrupt an execution of one of the processes.

15. The system of claim 11, wherein the host operating system is a multi-CPU hardware platform that comprises a plurality of CPU processors.

16. The system of claim 11, wherein the host operating system is a multi-core CPU hardware platform that comprises a processor having a plurality of processor cores.

17. The system of claim 11, wherein the host operating system is a multi-threaded CPU hardware platform that comprises a processor having a plurality of virtual processing elements.

18. The system of claim 11, wherein the target operating system is an object module for scaleable processor architecture.

19. The system of claim 11, wherein the target operating system is a fully linked object module in ELF format comprising an ELF header.

20. The system of claim 19, further comprising:
a transferring element transferring an execution of the forked plurality of processes to an entry point of the object module in accordance with the ELF header.

21. A computer readable storage medium including a set of instructions executable by a processor, the set of instructions operable to:
load a target operating system into a host operating system, wherein the host processing space includes a memory pool;
map the memory pool into a plurality of processes;
schedule tasks within one of the processes to create a multitasking environment;
fork the plurality of processes;
share the mapped memory pool and the loaded target operating system with the forked plurality of processes, thereby providing the plurality of processes with shared access to the memory pool; and
manage the scheduled tasks within the multitasking environment.
